(19) United States
(12) Patent Application Publication
(10) Pub. No.: US 2008/0147927 A1
(43) Pub. Date: Jun. 19, 2008

(54) Storage Device Interface and Storage Device with the Same

(75) Inventor: Fan-Sheng Lin, Taipei (TW)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: Etrovision Technology, Taipei (TW)

(21) Appl. No.: 11/626,843

(22) Filed: Jan. 24, 2007

(30) Foreign Application Priority Data
Oct. 13, 2006 (TW) 095137776

(51) Int. Cl. G06F 13/38

(52) U.S. Cl. 710/62

(57) ABSTRACT

A storage device interface is provided, which includes a device end interface and a device end serial interface, wherein the device end interface and the device end serial interface are disposed in a microprocessor, such that the microprocessor activates one of the device end interface and the device end serial interface in response to a diagnosis signal.

This non-provisional application claims priority under 35 U.S.C. §119(a) on Patent Application No(s). 095137776 filed in Taiwan, R.O.C. on Oct. 13, 2006, the entire contents of which are hereby incorporated by reference.

### BACKGROUND OF THE INVENTION

1. Field of Invention

The present invention relates to a storage device, and more particularly to a storage device with multiple serial interfaces.

2. Description of the Related Art

In the existing universal serial bus (USB) disc drives, storage protocols of a USB mass storage class are mainly used. For an operating system, a memory in the form of disc drive is provided, and the memory can be used for the storage and copy of a file or for an identity certification.

Because a USB disc drive mostly has device driver programs built in a respective operating system and is completely integrated with its file system, it has a high usage compatibility. In addition, the USB disc drive has a small form factor and an increasing memory capacity, and thus it has gradually becomes a mainstream of portable storage devices.

Referring to FIG. 1, a system architectural view of a USB storage device disclosed by the prior art is shown. The USB storage device mainly includes a memory 100, a microprocessor 110 and a device end interface 120. The memory 100 is a solid state memory, for example, a NAND flash memory. The microprocessor 110 is responsible for processing USB-MSC (Mass Storage Device Class) commands from the host end and accessing the memory. The device end interface 120 is a physical interface at the USB device end, and is responsible for signal processing of the communication at USB device end.

Referring to FIG. 2, another system architectural view of the USB storage device disclosed by the prior art is shown, where a USB device end interface 131 is integrated into a microprocessor 130 so as to save the cost and reduce the volume.

A schematic architectural view of the USB storage device shown in FIG. 1 and 2, and a USB host is illustrated with reference to FIG. 3. The storage device, being on a computer platform, performs a file accessing command according to a requirement of a user or an application program 310. The command is translated by a file system 320 and transferred as a standard file accessing command to a USB-MSC interface 330. The USB-MSC interface 330 packs the accessing command as a command of an MSC protocol.

Next, a USB host end interface 340 sends a file accessing command signal of the above MSC protocol and transfers the command signal to the microprocessor 130 for processing, such that the microprocessor 130 of the USB disc drive reads or writes data of the memory 100 according to the command. Finally, the microprocessor 130 in the USB disc drive or storage device returns a completion state to the host end interface 340. The completion state is interpreted by the USB-MSC interface 330 and returned to the upper file system 320, such that the file system 320 and the application 310 feed the command completion state back to the user.

A USB disc drive is undoubtedly applicable to most of the computer platforms, but, if it is to be used in an embedded system as a storage interface of the system, the following disadvantages will arise. First, a host end hardware interface of the embedded system is very expensive, which is mainly because a USB standard specification adopts an asymmetric architecture by design so as to bring a low manufacturing cost and simple structure for a device end; on the contrary, the manufacturing cost for the host end hardware is high. Moreover, communication protocol stack for the host end hardware interface is very complex, which results in difficulty in designing a firmware of a microprocessor and increases the cost. Furthermore, although a variety of USB devices can be inserted onto the host end interface, due to the manufacturing cost and complexity of the embedded system, only limited driving programs can be interposed. Therefore, if only a MSC host driving program is interposed, the system will have no response and thus cannot correspond to a user's requirement when the user inserts another type of USB device (for example, a PC camera), thereby causing the user's misunderstanding and confusion.

### SUMMARY OF THE INVENTION

In view of the above, a storage device interface and a USB storage device with the same are disclosed in the present invention.

A storage device interface disclosed according to the present invention comprises a device end interface and a device end serial interface, wherein the device end interface and the device end serial interface are disposed in a microprocessor, such that the microprocessor activates one of the device end interface and the device end serial interface in response to a diagnosis signal.

A storage device disclosed according to the present invention comprises a memory, a microprocessor, a device end interface, a device end serial interface, a connection port and a diagnosis circuit. The microprocessor is connected and communicate with the memory, the device end interface and the device end serial interface are respectively disposed in the microprocessor, the diagnosis circuit is used to output a diagnosis signal according to a power supply signal output from the connection port, so as to determine the form of an external host system connected to the storage device, such that the microprocessor activates one of the device end interface and the device end serial interface in response to the diagnosis signal.

According to the present invention, the device end interface and the device end serial interface are connected to a connection port, wherein the connection port at least has two data pins, and the device end interface and the device end serial interface share the data pins.

According to the present invention, the device end serial interface adopts a serial interface having two pins.

According to the present invention, the device end serial interface adopts a communication interface comprising a CLOCK pin and a DATA pin.

According to the present invention, the device end serial interface adopts a communication interface comprising a receiver (RX) and a transmitter (TX).

In the storage device interface disclosed according to the present invention, an embedded processor sends an accessing command for a USB disc drive only via a simple host end serial interface. The command is received by a device end serial interface on the USB disc drive and transferred to a microprocessor for processing. The microprocessor accesses a memory according to a predefined protocol on the simple serial interface, and obtains a command completion state. The completion state is returned to the embedded processor through the host end serial interface and the device end serial interface, thus finishing the accessing command.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 is a system architectural view of a USB storage device disclosed by the prior art.

FIG. 2 is another architectural view of the USB storage device disclosed by the prior art.

FIG. 3 is a schematic view of the connection between the USB storage device disclosed by the prior art and a computer.

FIG. 4 is a system architectural view of a USB storage device disclosed by the present invention.

FIG. 5 is a schematic view of the connection between the USB storage device disclosed by the present invention and a computer and an embedded system.

FIG. 6 is a detailed circuit diagram of the USB storage device disclosed by the present invention.

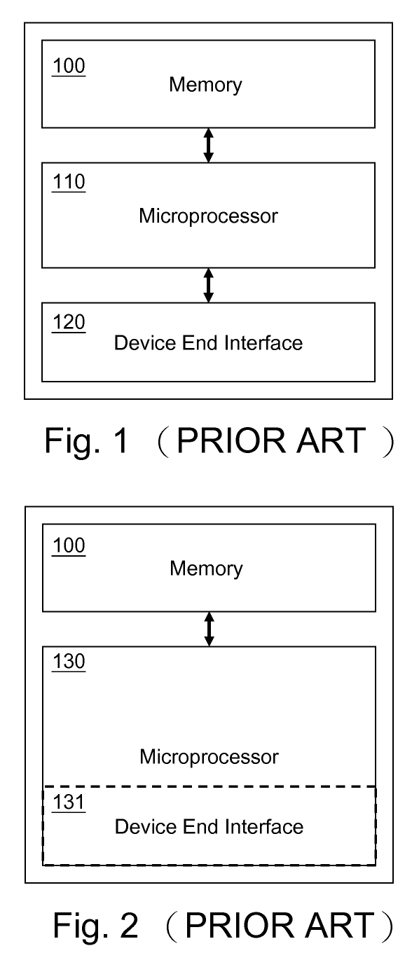

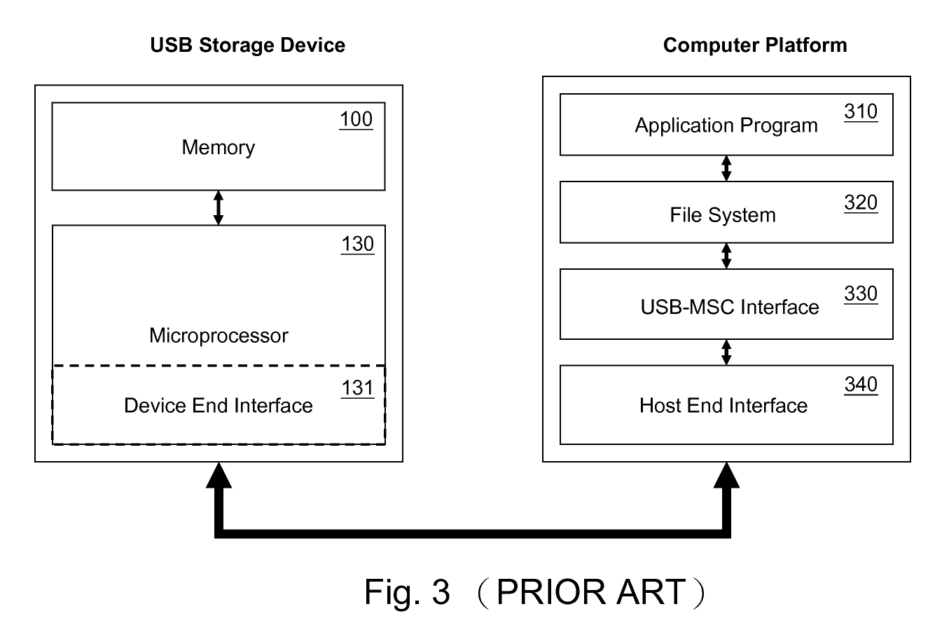

### DETAILED DESCRIPTION OF THE INVENTION

The characteristics and advantages of the present invention will be described in detail in the following detailed description, the content of which is enough for any one skilled in the art to understand the technology of the present invention and implement accordingly. Also, the relevant purposes and advantages of the present invention will be readily understood by any one skilled in the art with reference to the content disclosed by the specification, the claims and the figures.

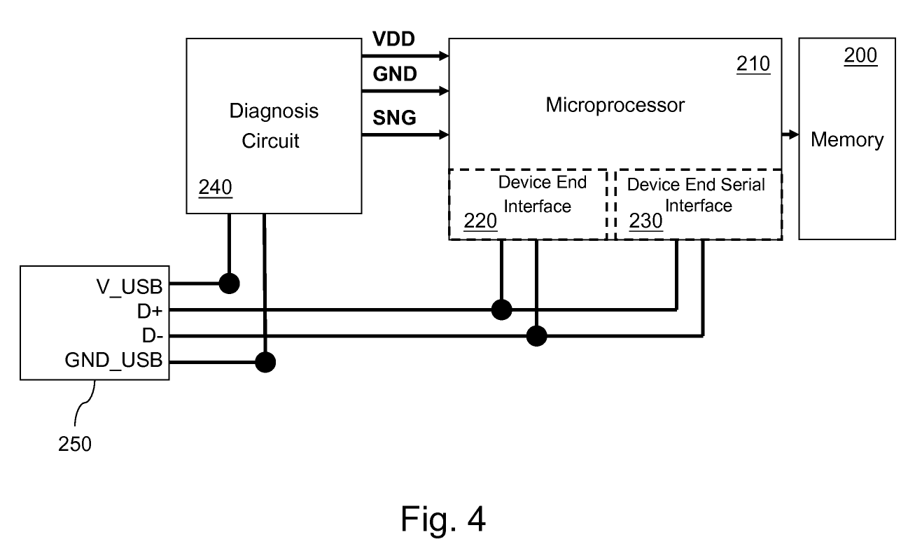

Referring to FIG. 4, a system architecture view of a USB disc drive disclosed by the present invention is shown. The USB storage device mainly includes a memory 200 and a microprocessor 210. The memory 200 is a solid state memory, for example, a NAND flash memory. The microprocessor 210 includes a device end interface 220 and a device end serial interface 230. Moreover, the USB disc drive is further provided with a diagnosis circuit 240.

The device end serial interface 230 is a serial interface, and in order to share a data transmission pin with a USB transmission port, the device end serial interface 230 adopts a serial interface having two pins. In an embodiment, a communication interface including a CLOCK pin and a DATA pin can be employed, for example, an I2C serial interface. In another embodiment, a communication interface including a receiver (RX) and a transmitter (TX), for example, a universal asynchronous receiver/transmitter (UART), can be employed.

Moreover, when the USB disc drive is connected to a host, the diagnosis circuit 240 can determine whether the host platform is a general computer platform or an embedded system according to signals from the V_USB and GND_USB pins, and output a diagnosis signal SNG accordingly, such that the microprocessor 210 activates the device end interface 220 or the device end serial interface 230 according to the diagnosis signal SNG.

Such a disc drive has a connection port 250 with four pins built in, and the four pins are respectively defined as V_USB, GND_USB, D+ and D−. The device end interface 220 and the device end serial interface 230 share the data pins, and thus the device end interface 220 is connected to the D+ and D− pins and the device end serial interface 230 is connected to the D+ and D− pins, while the rectification/diagnosis circuit 240 is connected to the V_USB and GND_USB pins. Such a connection port is only illustrative, and is not intended to limit a connection port that is applicable to the embodiment. In fact, any connection port with at least two data pins can be employed, where a device end interface and a device end serial interface share the two data pins of the connection port.

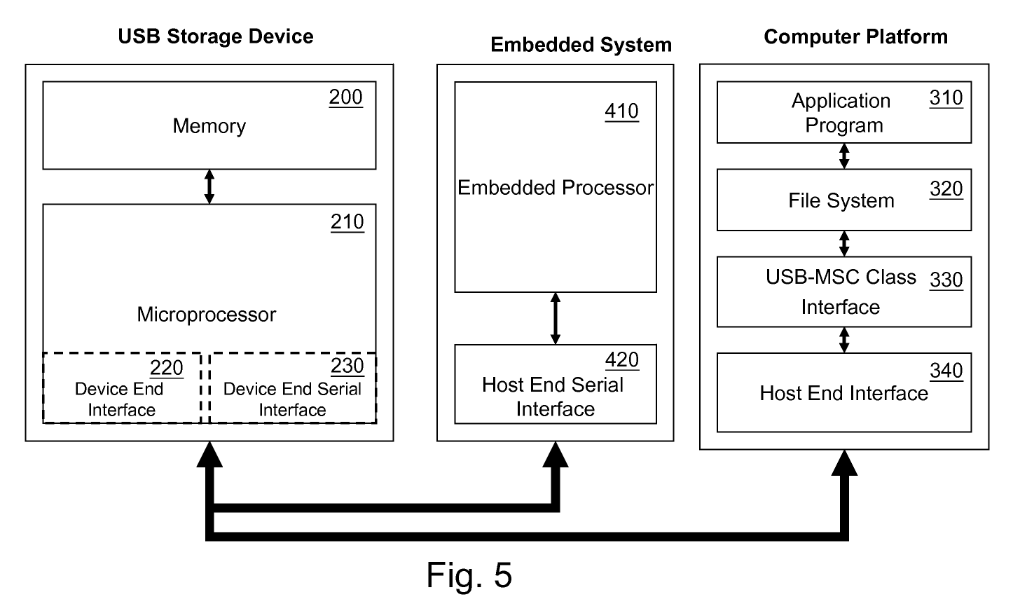

Referring to FIG. 5, a schematic view of the connection between a USB storage device disclosed by the present invention and a computer platform or an embedded system is shown. In an embodiment of the present invention, if the USB host end connected to the USB storage device is a general computer platform, the device end interface 220 of the microprocessor 210 is activated and the device end serial interface is disabled to spare the signal pins D+ and D−, in which case a general USB data transmission function is deployed.

When the USB storage device is connected to a general computer platform, the storage device performs a file accessing command according to a requirement of a user or an application program 310. The command is translated by the file system 320 and transferred as a standard file accessing command to a USB-MSC interface 330. The USB-MSC interface 330 packs the accessing command as a command of an MSC protocol.

Next, the USB host end interface sends the above file accessing command signal of the MSC protocol and transfers the command signal to the microprocessor 210 for processing, such that the microprocessor 210 of the USB disc drive reads or writes data of the memory according to the command. Finally, the microprocessor 210 in the USB disc drive returns a completion state to the host end interface 340. The completion state is interpreted by the USB-MSC interface 330 and returned to the upper file system 320, such that the file system 320 and the application 310 feed the command completion state back to the user.

If the USB host end connected to the USB storage device is an embedded system 400 platform, the device end serial interface 230 of the microprocessor 210 is activated, and the device end interface 220 is disabled to spare the signal pins, in which case the data pins D+ and D− are replaced by the device end serial interface 230 so as to communicate with a host end serial interface 420, and the host end serial interface 420 is controlled by an embedded processor 410 of the embedded system.

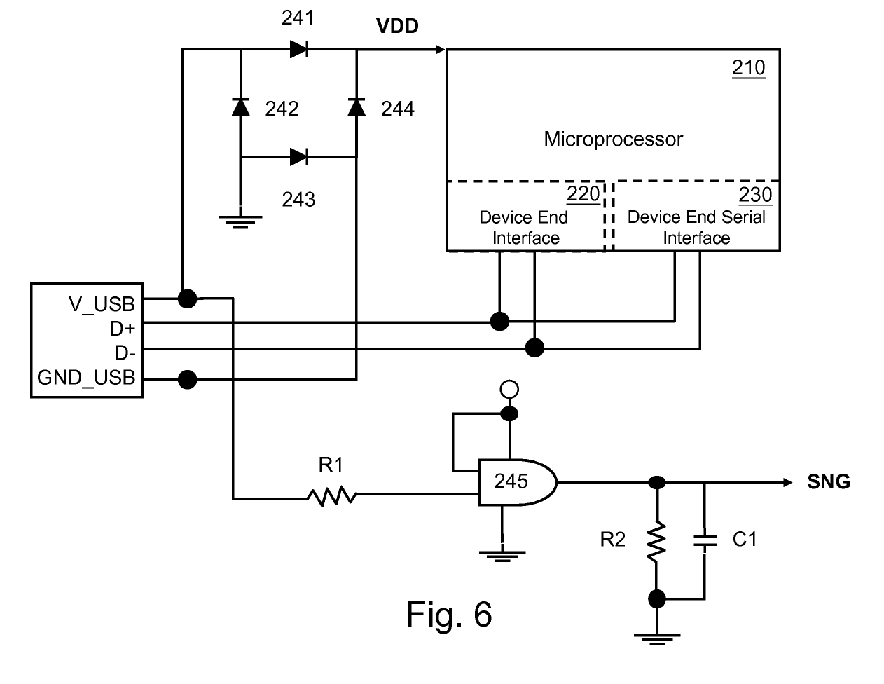

Referring to FIG. 6, a detailed circuit diagram of the USB storage device disclosed by the present invention is shown, which mainly depicts an embodiment of the diagnosis circuit 240.

The diagnosis circuit 240 includes a rectification circuit and a diagnosis circuit. The embodiment of FIG. 6 further includes a rectification circuit which is, for example, formed by connecting four diodes 241-244, for outputting a rectified power supply so as to be provided to the memory 200 (not shown in FIG. 6) and the microprocessor 210 for operation.

The diagnosis circuit provides a diagnosis on a connection mode for the microprocessor 210, so as to determine whether the host connected thereto is a computer or an embedded system. The exemplary embodiment as shown in FIG. 6 mainly includes an AND logic gate 245, and additionally includes resistors R1 and R2 and a capacitor C1 required by other circuits. The power supply of the AND logic gate 245 is provided by the rectification circuit, and a power supply provided by the rectification circuit and a power supply of V_USB are respectively wired to two input ends of the AND logic gate 245. A diagnosis signal SNG after the diagnosis of the AND logic gate 245 is transmitted to the microprocessor 210.

When a voltage of V_USB is higher than a voltage of GND_USB, the microprocessor 210 turns off the device end serial interface 230, and activates the circuitry of the device end interface 220 for performing data transmission and communication. When the voltage of V_USB is lower than the voltage of GND_USB, the microprocessor 210 turns off the device end interface 220, and activates the circuitry of the device end serial interface 230 for performing data transmission and communication.

A USB storage device disclosed according to the present invention can be used on a general computer platform, and is used in a completely same way as a general USB disc drive. Moreover, the storage device can be used on an embedded system platform with a simple design and a low manufacturing cost, so that the embedded system does not require a complicated USB host, and thus becomes a simple serial interface, thereby simplifying the architecture of the embedded system and its design and reducing the difficulty in development. Furthermore, the USB interface and the serial interface share a socket and connector of the USB, and an additional hardware interface is not required.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A storage device interface, comprising:
a device end interface; and
a device end serial interface;
wherein the device end interface and the device end serial interface are disposed in a microprocessor, such that the microprocessor activates one of the device end interface and the device end serial interface in response to a diagnosis signal.

2. The interface as claimed in claim 1, wherein the device end serial interface adopts a serial interface having two pins.

3. The interface as claimed in claim 1, wherein the device end serial interface adopts a communication interface comprising a CLOCK pin and a DATA pin.

4. The interface as claimed in claim 1, wherein the device end serial interface adopts a communication interface comprising a receiver (RX) and a transmitter (TX).

5. The interface as claimed in claim 1, wherein the device end interface and the device end serial interface are connected to a connection port, the connection port at least has two data pins, and the device end interface and the device end serial interface share the data pins.

6. A storage device, comprising:
a memory;
a microprocessor, connected to and communicated with the memory;
a device end interface, disposed in the microprocessor;
a device end serial interface, disposed in the microprocessor;
a connection port, for being connected to an external system; and
a diagnosis circuit, for outputting a diagnosis signal according to a power supply signal output from the connection port, so as to determine the form of the external system connected to the storage device, such that the microprocessor activates one of the device end interface and the device end serial interface in response to the diagnosis signal.

7. The storage device as claimed in claim 6, wherein the device end serial interface adopts a serial interface having two pins.

8. The storage device as claimed in claim 6, wherein the device end serial interface adopts a communication interface comprising a CLOCK pin and a DATA pin.

9. The storage device as claimed in claim 6, wherein the device end serial interface adopts a communication interface comprising a receiver (RX) and a transmitter (TX).

10. The storage device as claimed in claim 6, wherein the diagnosis circuit comprises a logic gate.

11. The storage device as claimed in claim 6, wherein the connection port at least has two data pins, and the device end interface and the device end serial interface share the data pins.

12. The storage device as claimed in claim 6, further comprising a rectification circuit for outputting a rectified power supply signal so as to be provided to the microprocessor and the memory.
